(19) United States
(12) Patent Application Publication
(10) Pub. No.: US 2024/0418505 A1
(43) Pub. Date: Dec. 19, 2024

(54) ULTRASONIC REMOTE CONDITION MONITORING SYSTEM

(71) Applicant: Evident Scientific, Inc., Waltham, MA (US)

(72) Inventor: Anthony E. Sayegh, Wayland, MA (US)

(21) Appl. No.: 18/702,892

(22) PCT Filed: Oct. 10, 2022
(86) PCT No.: PCT/US2022/077838

§ 371 Date: Apr. 19, 2024

Related U.S. Application Data
(60) Provisional application No. 63/270,750, filed on Oct. 22, 2021.

(51) Int. Cl. G01B 17/02; G01B 5/00

(52) U.S. Cl. CPC G01B 17/02; G01B 5/0014; G01B 2210/58

(57) ABSTRACT

Techniques for remotely monitoring a condition of an object at a location, such as remotely monitoring a thickness of a pipe to detect corrosion. In some examples, after installation, the service life of the system can be 5-10 years, for example, without intervention.

### CLAIM OF PRIORITY

This application claims the benefit of priority of U.S. Provisional Patent Application Ser. No. 63/270,750 titled “ENERGY HARVESTING REMOTE CONDITION MONITORING LOCATION SYSTEM” to Anthony E. Sayegh, filed on Oct. 22, 2021, the entire contents of which being incorporated herein by reference.

### FIELD OF THE DISCLOSURE

This document pertains generally, but not by way of limitation, to non-destructive evaluation, and more particularly, to apparatus and techniques for providing acoustic inspection, such as using ultrasound testing.

### BACKGROUND

Industrial non-destructive testing instruments are used for various types of applications, such as material flaw detection, corrosion monitoring, and thickness measurement. For example, ultrasound technology can be used for inspecting materials (e.g., pipes) in a non-destructive manner. In ultrasonic testing, a single element (conventional UT) or multiple elements such as phased array instruments are used to pulse on an object. The resulting echoes are received by the elements, digitized, and analyzed to highlight any flaws in the targeted test object. Each element can be used to both send and receive high-frequency sound waves or echo signals, or they can be paired so that one element acts as a transmitter, the other one as a receiver.

### SUMMARY OF THE DISCLOSURE

The present inventor has recognized the desirability of remotely monitoring the condition of assets in the field over time, without using a lot of power. Using various techniques of this disclosure, a system can remotely monitor a condition of an object at a location, such as remotely monitoring a thickness of a pipe to detect corrosion. In some examples, after installation, the service life of the system can be 5-10 years, for example, without intervention when using various techniques of this disclosure.

In an aspect, this disclosure is directed to a system for monitoring a condition of an object, the system comprising: an ultrasound transducer configured to be in contact with a surface of the object; and an electronics module electrically coupled to the ultrasound transducer, the electronics module comprising: a control unit configured to transmit a control signal to generate a transmit pulse to the ultrasound transducer that generates a transmit acoustic signal; and a time-to-digital converter coupled to the control unit and configured to receive, from the ultrasound transducer, a representation of a return acoustic signal from the object and determine a time between the transmit acoustic signal and the return acoustic signal, wherein the control unit is configured to determine a thickness of the object based on the determined time.

In an aspect, this disclosure is directed to an electronics module for monitoring a condition of an object, the electronics module comprising: a control unit configured to transmit a control signal to generate a transmit pulse to an ultrasound transducer that generates a transmit acoustic signal; and a time-to-digital converter coupled to the control unit and configured to receive, from the ultrasound transducer, a representation of a return acoustic signal from the object and determine a time between the transmit acoustic signal and the return acoustic signal, wherein the control unit is configured to determine a thickness of the object based on the determined time.

In an aspect, this disclosure is directed to a method of monitoring a condition of an object at a location, the method comprising: transmitting a control signal to generate a transmit pulse using an ultrasound transducer; receiving, from the ultrasound transducer, a representation of a return pulse from the object; determining, using a time-to-digital converter circuit, a time between the transmit pulse and the return pulse; and determining a thickness of the object based on the determined time.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a conceptual diagram of an example of a system that can implement various techniques in this disclosure.

FIG. 2 is a block diagram of an example of the system of FIG. 1.

FIG. 3 is a block diagram of an example of the receiver circuit of FIG. 2.

FIG. 4 is a graph depicting an example of simulated receiver output using real measurement data and using various techniques of this disclosure.

FIG. 5 is a graph depicting an example of a peak detection measurement, simulated using various techniques of this disclosure.

FIG. 6 is a flow diagram of an example of a method of monitoring a condition of an object at a location.

### DETAILED DESCRIPTION

Assets in the field, such as pipes, can degrade over time. For example, a pipe carry various substances that, over time, can corrode sections of the pipe. The corrosion can reduce the thicknesses of one or more sections of pipe, which can put the asset at greater risk of an eventual failure.

The present inventor has recognized the desirability of remotely monitoring the condition of assets in the field over time, without using a lot of power. Using various techniques of this disclosure, a system can remotely monitor a condition of an object at a location, such as remotely monitoring a thickness of a pipe to detect corrosion. In some examples, after installation, the service life of the system can be 5-10 years, for example, without intervention when using various techniques of this disclosure.

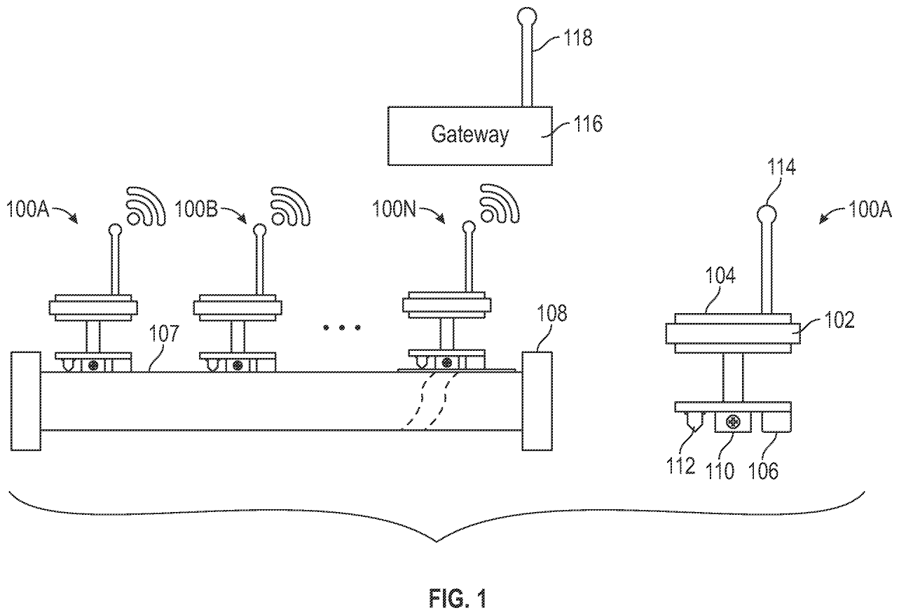

FIG. 1 is a conceptual diagram of an example of a system 100A that can implement various techniques in this disclosure. The system 100A is configured to monitor a condition of an object, e.g., an asset such as a pipe, at a location, such as a remote location. The system 100A includes an electronics module 102 positioned within a housing 104.

The system 100A includes an ultrasound transducer 106 configured to be in contact with the surface of the object. For example, the ultrasound transducer 106 is configured to be in contact with an outer surface 107 of a pipe 108. The system 100A optionally includes an energy-harvesting device 110 configured to be in contact with the surface of the object. The system 100A optionally includes a temperature sensor 112 configured to be in contact with the surface of the object. The electronics module 102 is electrically coupled to the ultrasound transducer 106, the optional energy-harvesting device 110, and the optional temperature sensor 112.

The temperature sensor 112 is configured to generate a temperature signal representing a temperature of the object. The control unit 202 is configured to compensate for changes in the temperature of the object using the temperature signal.

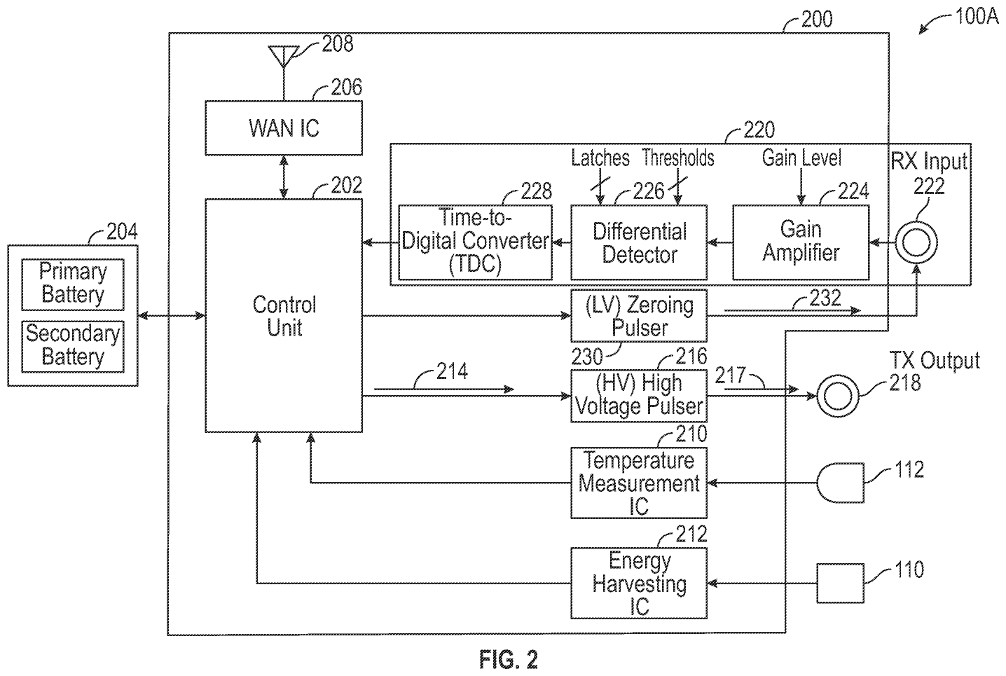

In some examples, the system 100A includes an antenna 114, such as to communicate, via WAN IC 206 of FIG. 2, with an optional gateway device 116 via its antenna 118. In an example of an implementation, multiple systems 100A can be positioned along a length of a pipe 108. For example, as shown in FIG. 1, systems 100A-100N are positioned along the length of the pipe 108 to monitor a condition, e.g., thickness, of the pipe 108, where the systems 100B-100N are similar to the system 100A.

In some examples, the systems 100A-100N can transmit information representing the condition, e.g., thickness, to the gateway device 116. The optional gateway device 116 can be in communication with one or more cloud servers, customer equipment, etc, to allow the monitoring of the condition(s) of the asset. The control unit 202 can perform a compression technique to compress data before transmission to the gateway 116.

FIG. 2 is a block diagram of an example of the system 100A of FIG. 1. The system 100A includes an electronics module 200 having a control unit 202 coupled to a battery 204. The electronics module 200 can further include a low-power wide area network (LPWAN) IC 206 having an antenna 208. In some examples, the WAN IC 206 can be integrated with and form a part of the control unit 202. In other examples, the WAN IC 206 can be separate from and electrically coupled to the control unit 202, such as shown in FIG. 2.

When the system 100A includes an optional temperature sensor 112, the electronics module 200 includes a temperature measurement IC 210 coupled to the control unit 202 and configured to receive information representing the temperature from temperature sensor 112. When the system 100A includes an optional energy-harvesting device 110, the electronics module 200 includes an energy-harvesting IC 212 coupled to the control unit 202 and configured to receive power from the energy-harvesting device 110. The control unit 202 can include power distribution functionality, such as in configurations including the optional energy-harvesting device 110. The control unit 202 communicates with various components of the system 100A and performs various functions, such as those described below.

The battery 204 can include a primary battery having one or more primary battery cells. In configurations that include the optional energy-harvesting device 110, the battery 204 can include a secondary battery having one or more secondary battery cells, such as rechargeable battery cells, which can receive a trickle charge generated from the energy-harvesting device 110, such as when the system 100A is asleep.

The control unit 202 is configured to transmit a control signal 214 to generate a transmit pulse to the ultrasound transducer 106 (of FIG. 1) that, in response, generates a transmit acoustic signal. More particularly, the control signal 214 is received by a pulser circuit 216, which is configured to generate a high voltage excitation pulse 217 to a transmit output port 218 to which the ultrasound transducer 106 is coupled. In response, the ultrasound transducer 106 generates an ultrasonic pulse designed to travel through the object under inspection, e.g., the pipe 108 of FIG. 1. The ultrasonic pulse that travels into the object will produce ultrasonic reflections from flaws, voids, and the like within the object called the return echoes, which are return acoustic signals. Transducer frequency can be selected based on a particular application.

The electronics module 200 includes a receiver circuit 220 to receive a representation of a return acoustic signal from the object via a receive input port 222 to which the ultrasound transducer 106 is coupled. The receive input port 222 is coupled to gain amplifier 224, such as a variable gain amplifier (VGA) or automatic gain amplifier (AGC). The gain amplifier 224 can receive a gain level as input.

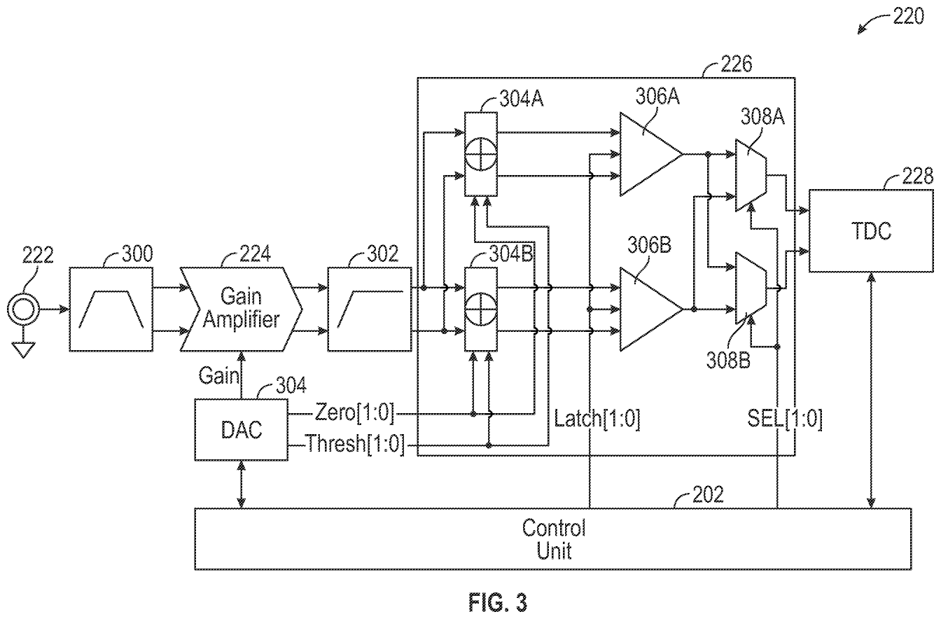

The receiver circuit 220 can further include a differential detector circuit 226 coupled to an output of the gain amplifier 224. The differential detector circuit 226 can be configured to receive various signals, such as latch signals and threshold signals, as described further with respect to FIG. 3.

The receiver circuit 220 can further include a time-to-digital converter circuit (TDC) 228 coupled to an output of the differential detector circuit 226 and configured to receive, from the ultrasound transducer, the representation of the return acoustic signal from the object and determine a time between the transmit acoustic signal and the return acoustic signal. The TDC 228 is coupled to an input of the control unit 202, and the control unit 202 is configured to determine a thickness of the object based on the determined time between the transmit acoustic signal and the return acoustic signal.

The electronics module 200 can further include a zeroing pulser circuit 230 coupled to the control unit 202 and configured to generate and transmit a zeroing pulse 232 to the receive input port 222. The zeroing pulse 232 is received and processed by the receiver circuit 220 to determine what delays are present in the receiver circuit 220, such as due to changes in temperature, etc. The zeroing pulse 232 has the same shape as the high voltage excitation pulse 217 but a smaller amplitude. Using the zeroing pulse 232, the control unit 202 can compensate for any changes in delay in the receiver circuit 220, such as due to temperature. For example, the control unit 202 can subtract the measurement achieved using the zeroing pulse 232 from the measurement achieved using the high voltage excitation pulse 217.

The time between the main pulse from the pulser circuit 216 and the first echo is measured to determine the time of flight. This time of flight includes the travel time of the transducer, which the control unit 202 can zero out using the measurement corresponding to the zeroing pulse 232 from the zeroing pulser circuit 230. The result of the total time of flight minus the zero time of the flight will be the travel time of sound in the material from front to back. Because the velocity of sound (m/s) is known for a given material, the control unit 202 can determine the thickness of the object.

FIG. 3 is a block diagram of an example of the receiver circuit 220 of FIG. 2. The receive input port 222 is coupled to a band-pass filter circuit 300, such as a 5 megahertz (MHz) band-pass filter circuit. The band-pass filter circuit 300 is coupled to inputs of the gain amplifier 224. The band-pass filter circuit 300 can be a single pole low-pass filter followed by a high-pass filter formed by the combination of a capacitor with the input impedance of the gain amplifier 224. The band-pass filter circuit 300 can attenuate out of band components of the signal before applying any amplification.

In some examples, the gain amplifier 224 receives a single-ended signal and generates a differential output signal at its outputs. Once amplified, the signal is now differential and centered about the reference voltage of the gain amplifier 224, such as 1.5V. The outputs of the gain amplifier 224 are coupled to a high-pass filter circuit 302, which removes the common mode voltage component.

The control unit 202 is coupled to a digital-to-analog converter circuit (DAC) 304. The control unit 202 can generate a gain level signal that is received by the DAC 304, converted, and then applied to the gain amplifier 224, thereby amplifying the signal. Using the gain level signal value, the DC offset of the amplified signals can be adjusted as to change the measurement thresholding.

The output of the high-pass filter circuit 302 is coupled to the differential detector circuit 226. In the example shown in FIG. 3, the differential detector circuit 226 includes summing stages 304A and 304B, comparator circuits 306A and 306B, and multiplexer circuits 308A and 308B.

The summing stages 304A and 304B are each coupled to the differential outputs of the high-pass filter circuit 302. In addition, an offset is added to each portion of the differential signal at the summing stages 304A and 304B so that their relative potentials can be processed by the next stage. As seen in FIG. 3, the control unit 202 outputs a first offset signal (ZERO[1:0]) and a second offset signal (THRESH[1:0]) that is converted by the DAC 304 and applied to the summing stages 304A and 304B.

The outputs of the summing stage 304A are coupled to corresponding inputs of the comparator circuit 306A, and the outputs of the summing stage 304B are coupled to corresponding inputs of the comparator circuit 306B. The comparator circuits 306A and 306B act like 1-bit analog-to-digital converter circuits in that they sample the input signal. In some examples, the comparator circuits 306A and 306B are dual latched comparators coupled to the offset node. Latching the comparator circuits 306A and 306B for a period of time after the pulser circuit 216 generates the high voltage excitation pulse 217 can prevent triggering due to noise or artifacts.

The positive and negative portions of the differential signal are set relative to one another and the comparator circuits 306A and 306B trigger based on their relative positions. By comparing the relative potentials of the positive and negative portions of the differential signal at the positive and negative inputs, the comparator circuits 306A and 306B can sample the inputs to generate a time-voltage digital waveform like pulse time modulation. Due to the signals being sampled relative to each other at the input (differentially), the effects of offset and noise present in the analog front end will tend to cancel out. This has the effect of reducing false positives and improving the detection resolution and precision.

The multiplexer circuit 308A and the multiplexer circuit 308B are coupled to corresponding outputs of the comparator circuit 306A and the comparator circuit 306B, e.g., dual latched comparator circuits. Similarly, the multiplexer circuit 308B is configured to receive the outputs of both the comparator circuit 306A and the comparator circuit 306B. The control unit 202 can generate a select signal (SEL[1:0]) to select an output of either the multiplexer circuit 308A or the multiplexer circuit 308B, or both. The output of the multiplexer circuit 308A and/or the output of the multiplexer circuit 308B is applied to corresponding inputs of the TDC 228, e.g., a dual channel TDC. In some examples, the TDC 228 is a digital counter. The TDC 228 can be a dual channel counter that can capture up to 10 time events (5 for each counter) with picosecond resolution, for example.

After the comparator circuits 306A and 306B generate their corresponding outputs, the control unit 202 can generate and output select signals to either the multiplexer circuit 308A or the multiplexer circuit 308B, or both, to select which of the two comparator outputs to sample, where each comparator represents a channel, and each channel can be associated with a different threshold value. For example, it can be desirable to sample one edge from both channels or two edges from a signal channel. One edge from both channels allows for dual threshold detection, which can be used in situations where there is a concern of the threshold being at the edge. Two edges from a single channel allows the tracking of the peaks of the sinusoids that are located between the rising and falling edge of pulses.

After generating the digital pulse train, the TDC 228 can measure when each pulse arrives relative to a start signal (synchronized to the main pulse sent). Internally, the TDC 228 has a masking period that allows it to only register pulses that have occurred within a window of time after the start signal. The control unit 202 can convert the signals to a time value and determine a thickness measurement of the object. After performing the thickness measurement, the system 100A can enter a sleep mode in which the energy-harvesting device 110, when present, recharges the secondary battery and provides power to various components in the electronics module 200, as needed, during the sleep mode.

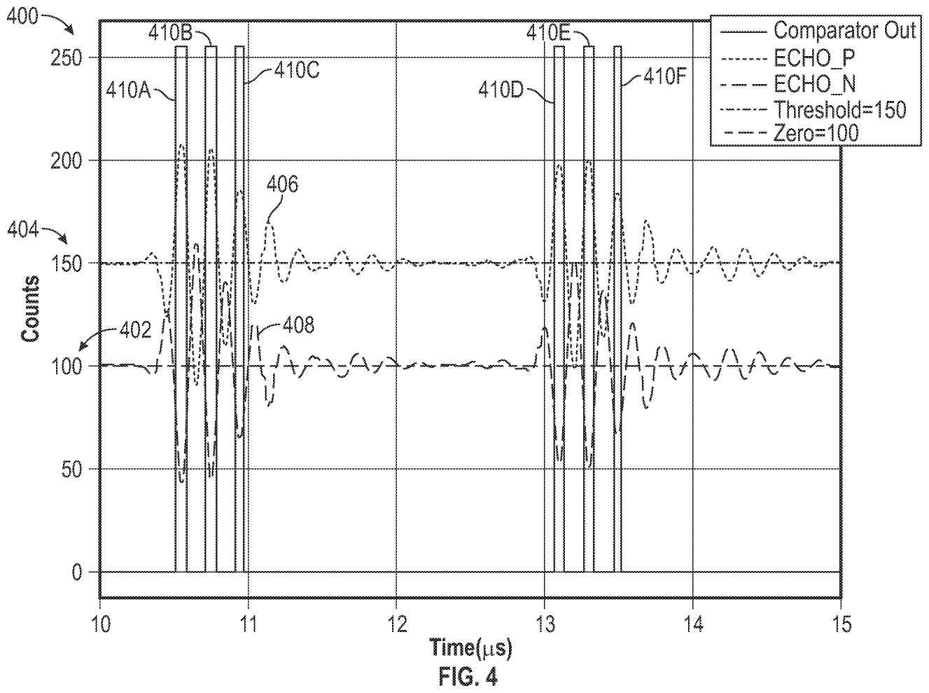

FIG. 4 is a graph depicting an example of simulated receiver output using real measurement data and using various techniques of this disclosure. FIG. 4 depicts the time of flight of 5 MHz echoes, which is the frequency response from the transducer, after insonifying a portion of steel having a thickness of 0.3 inches. The x-axis represents time in microseconds and the y-axis represents amplitude.

The graph 400 depicts a first DC threshold 402 (ZERO[1:0] in FIG. 3) and a second (higher) DC threshold 404 (THRESH[1:0] in FIG. 3). The positive portion of the differential signal 406 (“ECHO_P”) and the negative portion of the differential signal 408 (“ECHO_N”) are set relative to another at the two different DC thresholds. The comparator circuits 306A and 306B of FIG. 3 will trigger based on the relative positions of the positive portion of the differential signal 406 (“ECHO_P”) and the negative portion of the differential signal 408 (“ECHO_N”) and generate comparator output pulses 410A-410F forming a pulse train in time. Depending on whether the positive portion of the differential signal 406 (“ECHO_P”) is higher or lower than the negative portion of the differential signal 408 (“ECHO_N”), the comparator outputs 410A-410F will be set to a high or low state. The outputs of the comparator circuits 306A and 306B of FIG. 3 are eventually applied to the TDC 228 of FIG. 3, which converts those signals to time.

As seen in FIG. 4, the comparator output is pulse-time modulated, where output pulse 410A has a longer width (time) then either the output pulse 410B or the output pulse 410C. The width of the comparator output pulses depends on the height (counts) of the signal and where the two signals cross one another.

The resulting pulse train of output pulses 410A-410F are applied to the multiplexer circuits 308A and 308B of FIG. 3 and the control unit 202 of FIG. 3 can select one or both channels. Selecting a particular channel can allow tracking of the peaks of the positive portion of the differential signal 406 (“ECHO_P”) and/or the negative portion of the differential signal 408 (“ECHO_N”). In some examples, the control unit 202 can use the first pulse 410A to determine a thickness of the object.

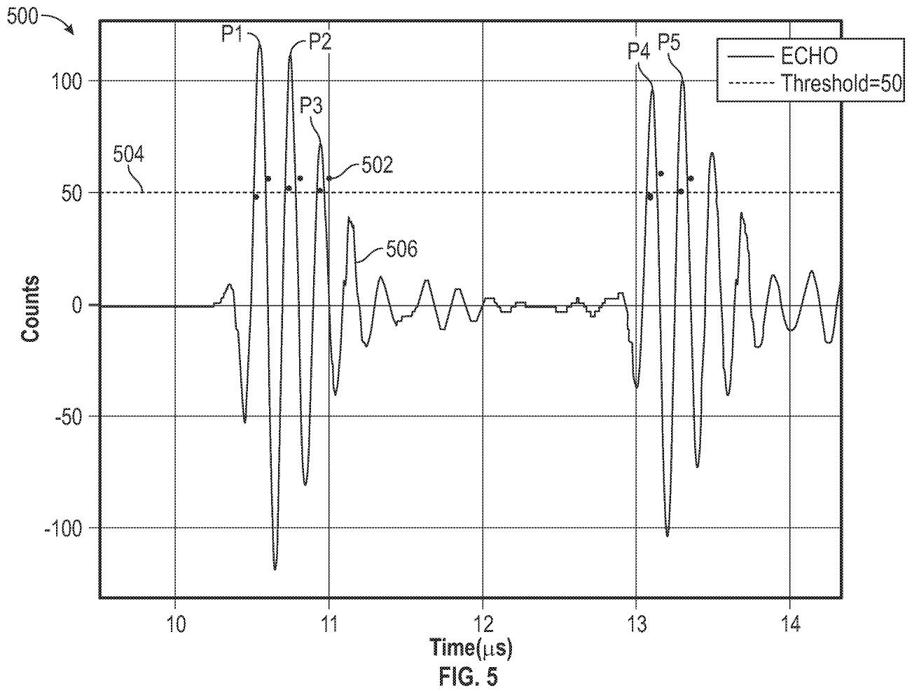

FIG. 5 is a graph depicting an example of a peak detection measurement, simulated using various techniques of this disclosure. FIG. 5 depicts the time of flight of 5 MHz echoes, which is the frequency response from the transducer, after insonifying a portion of steel having a thickness of 0.3 inches. The x-axis represents time in microseconds and the y-axis represents amplitude. In this particular example, the signal is resolved to single ended, meaning the differential is subtracted from each other and, the threshold is a result of this, e.g., 150−100=50.

In the graph 500 of FIG. 5, the 10 TDC values 502 (shown as * in FIG. 5) are points in time capture by the TDC 228 of FIG. 3 redrawn on an A-scan to compare the true location of peaks. The graph 500 depicts a DC threshold 504. In the example shown, the negative portion of the differential signal 506 (“ECHO_N”) is depicted.

For a particular threshold, such as the threshold 504, and given that the signal is a sinusoid and has a constant frequency, the control unit 202 of FIG. 3 can detect a rising edge and a falling edge. Then, the control unit 202 can determine that a peak is in located in time between the rising edge and the falling edge. As seen in FIG. 5, the control unit 202 identified five peaks P1-P5 using ten edges. In this manner, the control unit 202 can extract peak information of the echoes.

A non-limiting example of performing a measurement is described below for the purpose of explanation only. Enable the analog front end (AFE) and latch the comparators. Configure the AFE by reading a measurement setup from memory. There are three items that can be configured within the AFE to make an appropriate measurement: 1) VGA gain level; 2) Threshold and Zero values; and 3) Multiplexor inputs.

Start the measurement clock. The source can be from a clock output of the control unit or an external oscillator. Enable and configure the TDC. Start an internal timer (e.g., 1 MHz for 1 μs resolution delay. Wait for trigger signals from the TDC.

Enable and trigger the pulser circuit. Wait 5 us after the pulse, then de-latch the comparators. This operation helps ensure that the comparators are not latched during the noisy part of the echo. In one example implementation, the time travel time can be about 7 μs. The delay value used is based on the minimum thickness. For example, in 0. 1 in steel, the first echo is seen at within 8 μs-9 μs.

Wait for the Interrupt Service Routine (ISR) from TDC indicating data is ready to read from register. It can be desirable to avoid reading from the TDC until the measurement is complete. For one example of a TDC, there are 2 ISRs—one for each TDC inside the device. A readout of each of TDC's set of data registers is gated by the interrupt.

Disable the pulser, AFE, and latch comparators so as to not consume any extra energy while the data is being read out from the TDCs. Read data from TDCs and check the data. After the data has been collected, it can be checked using a multi-try system, for example. Once a measurement has been approved by the checking system, the control unit can collect all system and environmental measurement data and prepare the data for transmission.

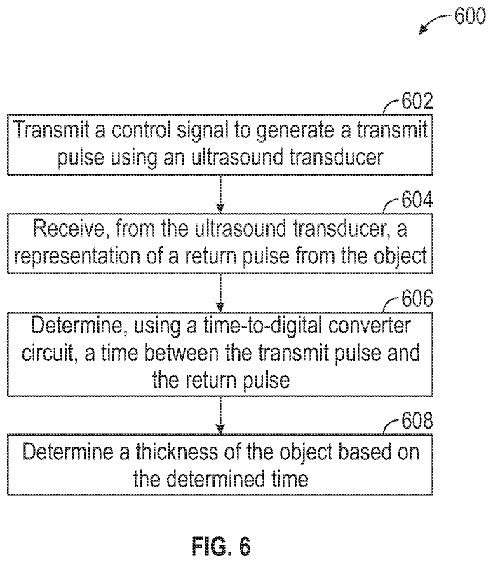

FIG. 6 is a flow diagram of an example of a method 600 of monitoring a condition of an object at a location. At block 602, the method 600 includes transmitting a control signal to generate a transmit pulse using an ultrasound transducer. For example, the control unit 202 of FIG. 2 can generate a transmit the control signal 214 to the pulser circuit 216 that, in turn, generates the high voltage excitation pulse 217 to an ultrasound transducer coupled to the transmit output port 218, such as the ultrasound transducer 106 of FIG. 1.

At block 604, the method 600 includes receiving, from the ultrasound transducer, a representation of a return pulse from the object. For example, the receiver circuit 220 of FIG. 2 can receive from the ultrasound transducer 106 of FIG. 1 a representation of the return pulse from the object.

At block 604, the method 600 includes determining, using a time-to-digital converter circuit, a time between the transmit pulse and the return pulse. For example, the TDC 228 of FIG. 2 can determine a time between the transmit and return pulses.

At block 604, the method 600 includes determining a thickness of the object based on the determined time. For example, the control unit 202 of FIG. 2 can determine the thickness of the pipe 108 of FIG. 1 based on the determined time between the transmit and return pulses.

In configurations that include an optional temperature sensor, the method 600 can include generating, using a temperature sensor coupled to a surface of the object, a temperature signal representing a temperature of the object, and compensating for changes in the temperature of the object using the temperature signal.

In configurations that include an optional energy-harvesting device, the method 600 can include receiving power from an energy-harvesting device coupled to a surface of the object, and storing the received power in a battery.

By using the various techniques of this disclosure described above, a system can remotely monitor a condition of an object at a location, such as remotely monitoring a thickness of a pipe to detect corrosion.

### Various Notes

Each of the non-limiting aspects described herein can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

The claimed invention is:

1. A system for monitoring a condition of an object, the system comprising:
an ultrasound transducer configured to be in contact with a surface of the object; and
an electronics module electrically coupled to the ultrasound transducer, the electronics module comprising:
a control unit configured to transmit a control signal to generate a transmit pulse to the ultrasound transducer that generates a transmit acoustic signal; and
a time-to-digital converter coupled to the control unit and configured to receive, from the ultrasound transducer, a representation of a return acoustic signal from the object and determine a time between the transmit acoustic signal and the return acoustic signal,
wherein the control unit is configured to determine a thickness of the object based on the determined time.

2. The system of claim 1, comprising:
a temperature sensor configured to be in contact with the surface of the object and in electrical communication with the control unit, wherein the temperature sensor is configured to generate a temperature signal representing a temperature of the object,
wherein the control unit is configured to compensate for changes in the temperature of the object using the temperature signal.

3. The system of claim 1, comprising:
a first pulser circuit coupled to the control unit and configured to generate and transmit a first pulse to the ultrasound transducer; and
a second pulser circuit coupled to the control unit and configured to generate and transmit a second pulse to a receiver input,
wherein the control unit is configured to compensate for a change in delay using the second pulse.

4. The system of claim 1, further comprising:
an energy-harvesting device configured to be in contact with the surface of the object, wherein the energy-harvesting device is electrically coupled to the electronics module.

5. The system of claim 4, comprising:
a primary battery coupled to the control unit; and
a secondary battery coupled to the control unit and to the energy-harvesting device, wherein the energy-harvesting device is configured to charge the secondary battery.

6. The system of claim 1, comprising a receiver circuit, wherein the receiver circuit includes:
a gain amplifier circuit coupled to a receiver input; and
a differential detector circuit coupled to the gain amplifier circuit, wherein the differential detector circuit is coupled to the time-to-digital converter.

7. The system of claim 6, wherein the gain amplifier circuit includes a variable gain amplifier circuit.

8. The system of claim 6, wherein the gain amplifier circuit is configured to generate a differential output signal.

9. The system of claim 6, wherein the differential detector circuit includes dual latched comparator circuits.

10. The system of claim 9, wherein the differential detector circuit includes multiplexer circuits coupled to corresponding outputs of the dual latched comparator circuits, wherein outputs of the multiplexer circuits are coupled to corresponding inputs of the time-to-digital converter.

11. The system of claim 6, wherein the receiver circuit includes:
a band-pass filter circuit coupled to an input of the gain amplifier circuit; and
a high-pass filter circuit coupled to an output of the gain amplifier circuit.

12. An electronics module for monitoring a condition of an object, the electronics module comprising:
a control unit configured to transmit a control signal to generate a transmit pulse to an ultrasound transducer that generates a transmit acoustic signal; and
a time-to-digital converter coupled to the control unit and configured to receive, from the ultrasound transducer, a representation of a return acoustic signal from the object and determine a time between the transmit acoustic signal and the return acoustic signal,
wherein the control unit is configured to determine a thickness of the object based on the determined time.

13. The electronics module of claim 12, comprising:
a receiver circuit, wherein the receiver circuit includes:
a gain amplifier circuit coupled to a receiver input; and
a differential detector circuit coupled to the gain amplifier circuit,
wherein the differential detector circuit is coupled to the time-to-digital converter.

14. The electronics module of claim 13, wherein the differential detector circuit includes dual latched comparator circuits.

15. The electronics module of claim 14, wherein the differential detector circuit includes multiplexer circuits coupled to corresponding outputs of the dual latched comparator circuits, wherein outputs of the multiplexer circuits are coupled to corresponding inputs of the time-to-digital converter.

16. The electronics module of claim 12, wherein the control unit is in electrical communication with a temperature sensor, wherein the temperature sensor is configured to be in contact with a surface of the object, wherein the temperature sensor is configured to generate a temperature signal representing a temperature of the object, and wherein the control unit is configured to compensate for changes in the temperature of the object using the temperature signal.

17. The electronics module of claim 12, wherein the control unit is in electrical communication with an energy-harvesting device, wherein the energy-harvesting device is configured to be in contact with a surface of the object.

18. A method of monitoring a condition of an object at a location, the method comprising:
transmitting a control signal to generate a transmit pulse using an ultrasound transducer;
receiving, from the ultrasound transducer, a representation of a return pulse from the object;
determining, using a time-to-digital converter circuit, a time between the transmit pulse and the return pulse; and
determining a thickness of the object based on the determined time.

19. The method of claim 18, comprising:
generating, using a temperature sensor coupled to a surface of the object, a temperature signal representing a temperature of the object; and
compensating for changes in the temperature of the object using the temperature signal.

20. The method of claim 18, comprising:
receiving power from an energy-harvesting device coupled to a surface of the object; and
storing the received power in a battery.
